(19) United States
(12) Patent Application Publication
(10) Pub. No.: US 2020/0394570 A1
(43) Pub. Date: Dec. 17, 2020

(54) SYSTEM WITH REAL-TIME DETECTION AND RESOLUTION OF CONFLICTS FOR SHARED RESOURCES

(71) Applicant: Citrix Systems, Inc., Ft. Lauderdale, FL (US)

(72) Inventor: Wenhao Ge, Nanjing (CN)

(21) Appl. No.: 16/461,171

(22) PCT Filed: Dec. 29, 2018
(86) PCT No.: PCT/CN2018/125444

§ 371 Date: May 15, 2019

(51) Int. Cl. G06Q 10/02; G06F 16/23; G06F 16/2455; G06Q 10/10

(52) U.S. Cl. CPC G06Q 10/02; G06Q 10/1095; G06F 16/24565; G06F 16/2379

(57) ABSTRACT

A method of managing shared resources includes detecting, upon receiving a request to extend a current use of a shared resource, a conflict in resource data between a requested end time of the current use and an earlier beginning time of a subsequent use. In one example the shared resource may be a conference room, the uses are adjacently scheduled meetings. The method further includes, in response to detecting the conflict, (1) receiving a permission indication with respect to the request, and (2) in response to the permission indication identifying acceptance of the request, (a) calculating a granted extension time for the current use, and (b) updating the resource data to add the granted extension time to a scheduled end time of the current use and the scheduled beginning time of the subsequent use to enable use of the shared resource without conflict.

### BACKGROUND

The disclosure relates to the field of resource management, for example in a calendar application that provides for scheduling of shared resources such as conference rooms, also referred to as “meeting rooms” herein.

### SUMMARY

The disclosure relates generally to a technique for management of shared resources to avoid conflicts in their use. In one example the disclosure includes a smart notification and workflow mechanism enabling better collaboration and efficient resource utilization. This general aspect is described with reference to a particular application example based on meeting data that describes usage of shared meeting resources such as conference rooms. Those skilled in the art will appreciate that the disclosed technique may be utilized in a variety of other ways.

In relation to the example of shared meeting resources, in today's enterprises a meeting is scheduled with a reservation of a particular conference room using client collaboration applications such as Microsoft® Outlook® Based on this scheduling, a start time and end time are assigned for this meeting and conference room. Then before the meeting starts, for example 15 minutes in advance, the application may send a reminder to the meeting owner and attendees to attend the upcoming meeting.

In some cases, a meeting room may still be occupied by a preceding meeting when the attendees for the upcoming meeting arrive, and the preceding meeting continues (either with or without permission) past the scheduled start time of the upcoming meeting. The start of the upcoming meeting is delayed, and productive time may be lost as a result. This scenario represents reduced organization efficiency. It arises partly by limitations of existing resource scheduling techniques, which do not recognize these types of conflicts nor provide any support for their resolution. Meeting attendees are left to recognize and resolve the conflicts on their own, with attendant inefficiency.

In a disclosed technique, an intelligent notification and workflow are provided in resource scheduling to reduce the incidence of such inefficient interactions over shared resources such as conference rooms. The disclosed technique uses a new decision approach to send notifications to resource owners to confirm extension of a current use of a shared resource, and updates resource data to reflect the extension and thereby proactively notify resource users of changes to scheduled usage, avoiding the need for the users to learn of a conflict and resolve it themselves. Resource data is data representing scheduled use of the shared resource, for example an electronic calendar or similar scheduling data. Additionally, the disclosed technique may use context information (e.g., history credit for the meeting room/user behaviors/etc.) and allocation policy in the granting of time extensions for uses of the resource.

More particularly, a method is disclosed of managing shared resources. The method generally includes detecting, in response to receipt of a request to extend a current use of a shared resource, a conflict in resource data between a requested end time of the current use and a beginning time of a subsequent use of the shared resource. In such cases, the requested end time is later than a scheduled beginning time for the subsequent use. In one example, the shared resource is a conference room and the conflict arises due to adjacencies m the scheduling of meetings in the conference room.

The disclosed method further includes, in response to detecting the conflict, (1) receiving a permission indication with respect to the request, and (2) in response to the permission indication identifying acceptance of the request, (a) calculating a granted extension time for the current use, and (b) updating the resource data to add the granted extension time to a scheduled end time of the current use and the scheduled beginning time of the subsequent use to enable use of the shared resource without conflict.

### BRIEF DESCRIPTION OF THE DRAWINGS

The foregoing and other objects, features and advantages will be apparent from the following description of particular embodiments, as illustrated in the accompanying drawings in which like reference characters refer to the same parts throughout the different views.

FIG. 1 is a block diagram of a system providing for management of shared resources;

FIG. 2 is a flow diagram of certain operation of the system of FIG. 1;

FIG. 3 is a block diagram of a distributed calendar system which is a specific example of the general system of FIG. 1;

FIG. 4 is a block diagram of calendar server equipment in the system of FIG. 3;

FIG. 5 is a block diagram of a calendar client device in the system of FIG. 3; and

FIG. 6 is a messaging diagram of certain operation of the system of FIG. 3.

### DETAILED DESCRIPTION

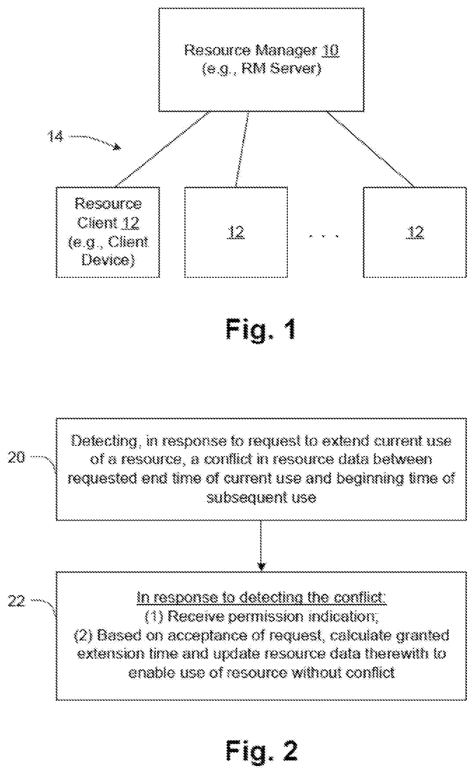

FIG. 1 shows a system including a resource manager 10 coupled to a set of resource clients 12 by respective communications links 14. Generally the resource manager 10 and resource clients 12 are computerized devices executing specialized software for realizing functionality as described herein. In particular, in one example the resource manager 10 may be realized as a resource manager server (RM server), and the resource clients 12 may be realized as respective client devices such as personal computers, smartphones, tablet computers, etc. As such, these computerized devices generally include one or more processors, memory, input/output (I/O) interface circuitry, and nonvolatile secondary storage for the storage and execution of computer program instructions and related data, as well as interacting with external devices, as generally known in the art.

In another more specific example, the system of FIG. 1 may be realized in the form of a distributed calendar application or distributed calendar functionality of a related application, such as for example the calendar function of Microsoft® Outlook®. In this case the resource clients 12 may be realized as computerized devices running instances of the client-side Outlook application, while the resource manager 10 may be realized as a centralized email server such as Microsoft Exchange®. Alternatively, the system may be realized in more of a peer-to-peer fashion employing no centralized server, in which case the functionality of the resource manager 10 is distributed across some set of peer devices that generally also include the functionality of a resource client 12.

FIG. 2 illustrates certain operation of the system of FIG. 1 at a high level. The functions are described as performed by the resource manager 10 in connection with data and communications involving the resource clients 12. In particular, the illustrated operation occurs in the context of shared use of a resource by the resource clients 12, with the resource manager 10 assisting with scheduling the use of the shared resource. In one example described in detail herein, the shared resource is a conference room used for meetings that are scheduled in a calendar or similar application. In that setting, the illustrated operation addresses the kind of potential problem described above, i.e., potential conflict for use of a conference room and the need for improved management of meeting data and communications in relation thereto. Those skilled in the art will appreciate that in general there may be many other types of resources and situation to which the illustrated technique may be applied.

At 20, the resource manager detects, in response to receipt of a request to extend a current use of a shared resource, a conflict in resource data between a requested end time of the current use and a beginning time of a subsequent use of the shared resource, where the requested end time is later than a scheduled beginning time for the subsequent use. The request may be received from a resource client 12 of a current user of the resource, for example. The resource data is data representing scheduled use of the resource, for example an electronic calendar or similar scheduling data. The resource manager 10 interrogates or otherwise queries the resource data to identify a next or subsequent use of the resource, and compares the beginning time of the subsequent use with the requested end time of the current use. If the requested end time is later, then a conflict has been detected—extending the current use as requested would cause it to extend past the beginning of the subsequent use.

At 22, in response to detecting the conflict, the resource manager (1) receives a permission indication with respect to the request, and (2) in response to the permission indication identifying acceptance of the request, (a) calculates a granted extension time for the current use, and (b) updates the resource data to add the granted extension time to a scheduled end time of the current use and the scheduled beginning time of the subsequent use, to enable use of the shared resource without conflict. Continuing with the above example, the resource manager 10 may receive a permission indication by first sending a notification message to the resource client 12 of a subsequent user associated with the subsequent use, for example a meeting organizer. The notification message conveys the request for extension of the current use. Based on user input, the resource client 12 then sends a reply message which includes the permission indication, either negative (rejection of request) or positive (acceptance of request).

The calculation of a granted extension time at 22 enables the resource manager 10 to exert certain independent control over resource usage, in particular with respect to usage under conflict conditions. For example, a current user may request an additional half-hour, but for any of a variety of reasons (including input from the subsequent user), only some shorter extension may be possible or desired. Examples are discussed below. Thus, this calculation may take a variety of inputs including historical usage data, policies, etc., and generate a granted extension time in accordance therewith.

The updating of resource data is generally visible in some manner to the current and subsequent resource users, enabling a conflict-free transition between the current and subsequent uses at a later time in accordance with the granted extension In a calendar application, for example, the schedules for a current meeting and a subsequent meeting are each adjusted to reflect a delayed end time for the current meeting and delayed beginning time for the next meeting. The resource clients 12 may automatically respond to the changes by issuing local notifications to users or other actions. Additionally, in some embodiments the resource manager 10 may also issue explicit communications to affected resource clients 12 to notify them of the change, in addition to the updating of the resource data.

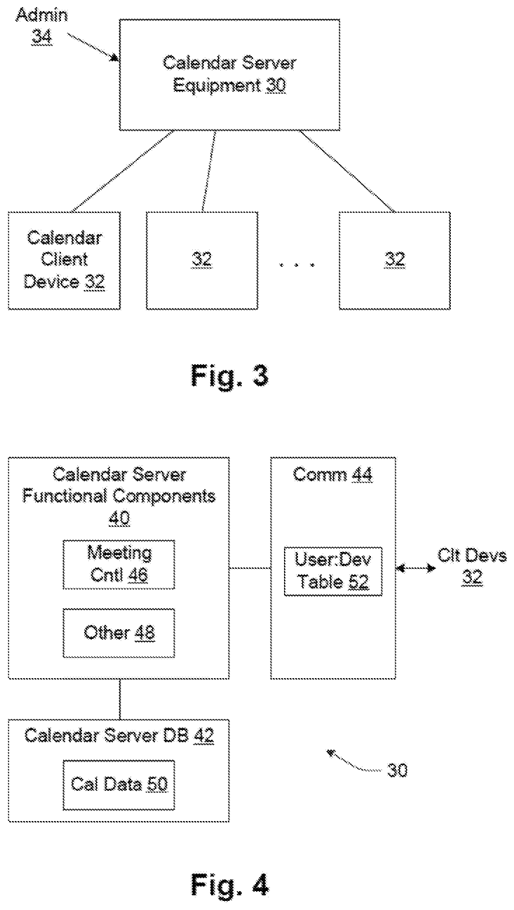

FIG. 3 shows a specific application of the general arrangement of FIG. 1, namely a distributed calendar system having calendar server equipment 30 and a set of calendar client devices 32. These may be realized as described above, i.e., as computerized devices executing specialized calendar-related software, including for example a distributed email system as mentioned above. The calendar server equipment 30 provides a specialized interface and communications with an external administrator (Admin) 34, who may program certain policies and other configuration data into the system for influencing certain aspects of operation as described herein. Policy data may be provided by the Admin 34 that explicitly describes associated policies for granting of extensions, and this data is used in the calculation of granted extension.

FIG. 4 shows the calendar server equipment 30 in one embodiment. This is a functional block diagram illustrating component realized by computer circuitry executing specialized calendar software. These components include calendar server functional components 40, a calendar server database 42, and a communications component 44.

The calendar server functional components 40 are generally those routines, linked libraries, etc., that realize the functionality of the calendar program, i.e., the ability to schedule meetings (i.e., create corresponding entries in the calendar server database 42), monitor for conflicts, engage in communications, etc. For purposes of this description these are divided into meeting control (Cntl) components 46 and other components 48, where the meeting control components 46 provide meeting-related functions specifically described herein and the other components 48 provide all other functions of the calendar application, as generally known in the art.

The calendar server database 42 stores calendar data 50 which underlies the calendar paradigm on which the system operates—data representing time periods (days, hours, etc.), scheduled items (e.g., meetings), users, resources such as conference rooms, etc. Example data and organization are shown below. It will be appreciated that the calendar data 50 is a specific example of what is also referred to as “meeting data” herein.

The communications component 44 carries out details of message exchange and/or notifications with the calendar client devices 32, and to this end it employs a user-device (user-dev) table 52 that associates users of the calendar system with corresponding calendar client devices 32 of those users. It will be appreciated that at a high level, a typical calendar system operates with respect to users (e.g., maintaining a user's calendar, identifying meeting participants, etc.), and thus requires a mechanism for communicating with the users. By associating users with devices 32 via the user-dev table 52, the communications component 44 provides such a mechanism.

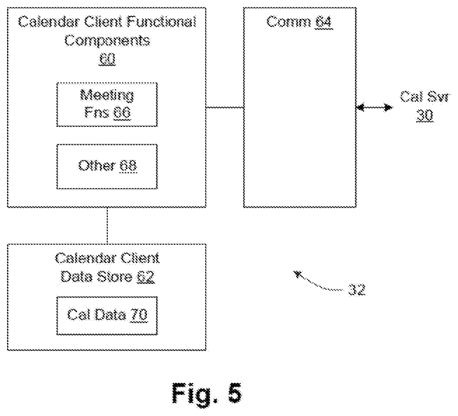

FIG. 5 illustrates a calendar client device 32 as having an organization analogous to that of the calendar server equipment 30. It includes calendar client functional components 60, a calendar client data store 62, and a communications component 64. The calendar client functional components include meeting functions 66 that implement meeting-related functionality as described herein, and other components 68 implementing the remaining client-side calendar components as generally known in the art. The calendar client data store 62 includes calendar data 70, which is maintained in synchronism with the calendar data 50 of the calendar server database 42 (FIG. 4) as generally known in the art. The communications component 64 provides for communications (messages and/or notifications) with the calendar server 30.

The following tables provide a simplified example of contents and organization of the calendar meeting data 50. The first table is a representation of scheduled meetings. The second table is a representation of scheduled uses of a given conference room, which is derived from the schedule information in the first table. These tables illustrate an example in which a first meeting identified as N is scheduled from 12:00 to 1:00, and a second meeting M is scheduled from 1:00 to 2:00, both in the same meeting room X.

TABLE 1
Meetings

| ID | Owner | Subject | Begin Time | End Time | Room | Participants |
|---|---|---|---|---|---|---|
| . . . | | | | | | |
| N | User N | Subj N | 12:00 | 1:00 | X | {List N} |
| M | User M | Subj M | 1:00 | 2:00 | X | {List M} |
| . . . | | | | | | |

TABLE 2
Room Usage

| Time Slot | Meeting |
|---|---|
| . . . | |
| 12:00-1:00 | N |
| 1:00-2:00 | M |
| . . . | |

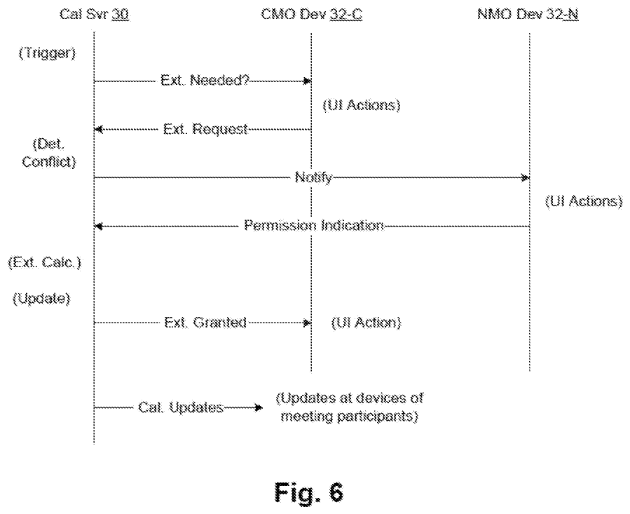

In operation, the meeting controller 46 can regularly scan the Room table (Table 2) for situations like that shown, i.e., two time-adjacent meetings, as a trigger for the process described below (with reference to FIG. 6) of communicating with meeting owners and updating meeting data to adjust schedules.

FIG. 6 is a messaging diagram illustrating operation of the system of FIG. 3 in one example. The participants are shown as the calendar server (Cal Svr) 30, a first client device 32 referred to as a “current meeting owner” device (CMO Dev) 32-C, and a “next meeting owner” device (NMO Dev) 32-M. The CMO device 32-C is associated with a user referred to as a “current meeting owner”, i.e., the organizer of a first meeting that is currently in progress. The NMO device 32-N is associated with a user referred to as a “next meeting owner”, i.e., the organizer of a second meeting that follows the current meeting on the schedule, typically immediately (i.e., the beginning time of the next meeting is within several minutes after the end time of the current meeting). In this messaging diagram, time progresses downwardly.

Operation initiates with occurrence of a trigger (Trigger) at the calendar server 30. In one example, the calendar server 30 continually scans the calendar data 50 (FIG. 4) for upcoming meeting ending times, and upon encountering one within some window the current time, treats this condition as the trigger of ensuing operation. As an example, the calendar server 30 may scan the schedules for all conference rooms every minute, and a trigger occurs upon encountering a scheduled ending time that is within 10 minutes of the current time. In alternative embodiments, the trigger condition may require not only an upcoming meeting ending time, but the presence of next-meeting beginning time within some window thereafter (e.g., within the next 15 or 30 minutes).

The calendar server 30 then sends a notification or other type of query message (Ext. Needed?) to the CMO device 32-C inquiring whether an extension of time is needed for the current use of the conference room. The CMO Device 32-C then performs one or more user interface actions (UI Actions) in an interaction with the local user, who is assumed to be the CMO user. For example, the CMO device 32-C may present a pop-up window with the inquiry message from the calendar server 30, and receive a button press or other user input indicating the CMO user's response to the inquiry. This response may be an indication that no additional time is needed, or that additional time is requested, and it may include the user inputting a specific value of the extension being requested (e.g., 15 minutes). Based on the UI Actions, the CMO device 32-C generates an extension request message (Ext Request) as a response message and sends it to the calendar server 30. It is assumed that the current user has requested an extension, and that the extension request message conveys the CMO user's request to extend the current use to a new ending time. Alternatively, the CMO device 32-C may generate and send a message indicating that no extension request is necessary, in which case the remaining steps of FIG. 6 as described below are not performed for this particular conference room and current meeting.

Next, the calendar server 30 performs a conflict detection operation (Det. Conflict) to determine whether the extension request presents a conflict for use of the conference room, based on the schedule in the calendar data 50 (FIG. 4). Generally a conflict occurs if the requested extension would cause the current meeting ending time to be beyond (later in time) the next meeting beginning time. If a conflict is detected, then the calendar server 30 generates and sends a notification message (Notify) to the NMO device 32-N, informing the next meeting owner of the requested extension. UI actions then occur at the NMO device 32-N, notifying the NMO user of the request and receiving input from the NMO user indicating whether they accept the request. Based on the UI actions, the NMO device 32-N generates a permission indication message (Permission Indication) and sends it to the calendar server 30. The permission indication message indicates whether the NMO user consents to a change of schedule represented by the extension request. For example, if the extension request is for 10 additional minutes, this may result in changing the next meeting beginning time by as much as 10 minutes. The permission indication message indicates acceptance or rejection of the extension and schedule change.

The calendar server 30 then performs an extension calculation (Ext. Calc.) to calculate a granted extension time, which in general may differ from the requested extension time. This calculation may use a variety of data and approaches in furtherance of certain operational goals or policies, and it may incorporate historical data to reflect past experience with the CMO user, for example. Specific examples are described below. After calculating the granted extension, the calendar server performs a local update of the server calendar data 50 (Update), notifies the CMO user by sending an extension granted message (Ext Granted) to the CMO device 32-C, and issues respective calendar updates (Cal. Updates) to the devices 70 of the current-meeting and next-meeting participants to update their respective client calendar data 70. Generally, the calendar update reflects the addition of the granted extension time to the scheduled end time of the current meeting and to the scheduled beginning time of the next meeting, thus moving these times correspondingly later. Once that is done, any local automated actions at each client device 32, such as local reminders, etc., are based on the adjusted times. Thus, the participants in the next meeting receive meeting reminders based on the adjusted beginning time of the next meeting, rather than based on the original schedule beginning time. In this way, the above-described problem of next-meeting participants having to wait outside a conference room for the current meeting to end is avoided, improving organization efficiency.

As an alternative to the above approach, the extension calculation may be performed prior to the notification and permission exchange with the NMO device 32-N, so that the NMO user is notified of the actual extension time to be granted, rather than the requested extension time.

It will be appreciated that there is a possibility of recursion occurring, i.e., that the process of FIG. 6 could be performed a second or subsequent time for the same current meeting, if a new trigger could occur based on the adjusted meeting ending time. Because the permission of the NMO user is required, such iteration would not result in an indefinite extension of the current meeting. However, it may be desirable to avoid any repetition of even the initial messaging of the process of FIG. 6 (Notify, Permission Indication), in which case the calendar server 30 may implement additional logic to identify ending times as adjusted times and inhibit any triggering of the process in response thereto (i.e., only one extension is permitted).

The following is a description of the extension calculation in one embodiment. It is assumed that a variety of data is stored in the server calendar data 50 as described below, some of which are static (e.g., meeting room identifiers), others being dynamic. Also, some data is tracked over time to create a historical record which is used as described. It is assumed that the current meeting owner has requested an extension that is represented as ExpectedDelayTime in the description below.
a. RoomId: a specific meeting room i.
b. StartTime: the normal beginning time of the meeting in the meeting room i;
c. EndTime: the normal ending time of the meeting in the meeting room i;
d. TimeForReminder: the ahead time to remind the next meeting owner to start the meeting in the meeting room i;
e. PriorFrequency: the historical accumulative times that the owner completed meetings early in the meeting room i, identified by the variable n;
f. DelayFrequency: the historical accumulative times that the owner delayed meetings (extended them beyond scheduled end times) in the meeting room i, identified by the variable m;
g. PriorCompleteTime: the time duration that the meeting is finished in advance compared to EndTime in the room i, identified as PriorTimeₖ. The k here equals to 1, 2, . . . , n, where n is the PriorFrequency explained above.
h. DelayCompleteTime: the time duration that the meeting is delayed compared to EndTime in the room i, identified as Delay-Timeⱼ. The j here equals to 1, 2, . . . , m, where m is the DelayFrequency explained above.
i. MaxPriorTime: the maximum remaining time duration when the owner finished the meeting in this room in advance compared to the EndTime, identified as TPMAXᵢ for a specific room i. Generally for a specific room, this may be a constant value bigger than the PriorCompleteTime. Therefore in certain time slot request scenarios, PriorTimeₖ is always not more than TPMAXⱼ.
j. MaxDelayTime: the maximum time duration that the owner can request compared to the EndTime in the meeting room i, identified as TDMAXᵢ for a specific room i. Generally for a specific room, this may be a constant value bigger than the DelayCompleteTime. Therefore in certain time slot request scenarios, DelayTimeⱼ is always not more than TDMAXᵢ.
k. NumberOfAttendees when prior: the number of participants of the next meeting in the room i in the Prior scenario, identified in historical record as PNumₖ.
l. NumberOfAttendees when delay: the number of participants of the next meeting in the room i in the Delay scenario, identified in the historical record as DNumⱼ.
m. PunishmentFactor: A normalized weight factor (between 0.0-1.0) used i calculating granted extension time and representing the effect of previous Delay events. It may be calculated by the formula below:

$${PunishmentFactor}_{i} = {\sum }_{j = 1}^{m} {DelayTime}_{j} * {DNum}_{j} \text{/} ( {TDMAX}_{i} * {\sum }_{j = 1}^{m} {DNum}_{j} )$$

n. RewardFactor: Analogous to the PunishmentFactor but representing the effect of previous Prior events. It may be calculated by the formula below:

$${RewardFactor}_{i} = {\sum }_{k = 1}^{n} {PriorTime}_{k} * {PNum}_{k} \text{/} ( {TPMAX}_{i} * {\sum }_{k = 1}^{n} {PNum}_{k} )$$

o. MeanFactor this is a mean factor used in calculating the granted extension time GrantedDelayTime, explained below. In one embodiment, a “credit” type of approach is used in granting time extensions. A meeting owner may be given an initial credit value, such as 1.0, for the MeanFactor for a given meeting room. According to the above definitions and formulas, as to meeting room i, the more Delays by that owner, the larger the PublishmentFactor is. And regarding the RewardFactor, the more Prior events completed by that owner (completing meetings early), the larger the RewardFactor is. TheMeanFactor may then be calculated as follows:

MeanFactorᵢ=1.0−PunishmentFactorᵢ+RewardFactorᵢ

The following explains how the actual granted extension time, GrantedDelayTime, is determined using the above values.
1. Calculate RewardFactorᵢ and PunishmentFactorᵢ based on the meeting owner's historical data stored in the server calendar data 50;
2. Calculate the MeanFactorᵢ for the meeting room i;
3. Calculate GrantedDelayTime as follows:
   a) If MeanFactorᵢ<=0, set GrantedDelayTime to 0.0;
   a) If MeanFactorᵢ>=1, set GrantedDelayTime to ExpectedDelayTime (the amount requested by the current meeting owner);
   c) Otherwise, calculate GrantedDelayTime as follows, which represents a scaling of ExpectedDelayTime by the MeanFactor:

GrantedDelayTime=ExpectedDelayTime*MeanFactorᵢ

Alternatives

In addition to functionality as described above, it may be possible to introduce other methods to smartly decide when to prompt the owner if it's needed to reserve additional time and to grant the proper amount of extra time based on configured policies other than context information. Such methods may include deep-learning techniques for detecting the meeting participants' behavior of sound and video information, for example.

It may be possible to integrate the technique with Internet of Things (IoT) hardware or supplies for a meeting room to set up a smart workspace. For example, the meeting controller may automatically disable the usage of the meeting room (e.g., closing the displays/disabling the cables) if the current meeting owner delays the meeting excessively and does not respond to notifications appropriately.

The disclosed technique generally may be used in other ways beyond managing conflicts over meeting rooms. In one example, it may be used m connection with other meeting-related shared resources such as conferencing services or devices, e.g., conference audio/video equipment, conferencing telephone lines, etc. More generally, it may be used in connection with other types of shared resources not necessarily involved with meetings. These may include high-demand devices such as copiers or scanners in an office environment; test equipment or other specialized tools in a factory or shop environment; etc.

While various embodiments have been particularly shown and described, it will be understood by those skilled in the art that various changes in form and details may be made therein without departing from the scope defined by the appended claims.

What is claimed is:

1. A method of managing shared resources, comprising:
detecting, in response to receipt of a request to extend a current use of a shared resource, a conflict in resource data between a requested end time of the current use and a beginning time of a subsequent use of the shared resource, the requested end time being later than a scheduled beginning time for the subsequent use; and
in response to detecting the conflict, (1) receiving a permission indication with respect to the request, and (2) in response to the permission indication identifying acceptance of the request, (a) calculating a granted extension time for the current use, and (b) updating the resource data to add the granted extension time to a scheduled end time of the current use and the scheduled beginning time of the subsequent use to enable use of the shared resource without conflict.

2. The method of claim 1, wherein the shared resource is a shared meeting resource, and the resource data is meeting data.

3. The method of claim 2, wherein the shared meeting resource is a conference room.

4. The method of claim 3, wherein (1) the current use and subsequent use are respective meetings scheduled by respective meeting owners, (2) the request is received from a first client device associated with a current meeting owner for a current meeting, and (3) the permission indication is received from a second client device associated with a next meeting owner for a subsequent meeting.

5. The method of claim 1, wherein the updating of the resource data includes updating of data stored at resource client devices, and further including, at the resource client devices, generating local notifications to respective resource users based on the updated data, the local notifications informing the resource users of an adjusted time of the current use and the adjusted beginning time of the subsequent use.

6. The method of claim 1, wherein calculating the granted extension time includes calculations based on historical resource data concerning past time extensions.

7. The method of claim 6, wherein the calculations based on historical resource data include use of a punishment factor and a reward factor, the punishment factor used to reduce the granted extension time based on past occurrences of extension requests for the shared resource, the reward factor used to offset the punishment factor and thereby increase granted extension time based on past occurrences of early completions of use of the shared resource.

8. The method of claim 7, wherein the calculations further include weighting factors representing a number of users affected by the past occurrences of extension requests and early completions of use.

9. The method of claim 6, wherein the calculations based on historical resource data are additionally based on policy data explicitly describing associated policies for granting of extensions.

10. The method of claim 1, further including, based on occurrence of a trigger, sending a query message to a device of a current user of the shared resource, and wherein the request is received as a response to the query message.

11. A resource management system having one or more computerized devices collectively configured and operative to manage shared resources, the computerized devices including respective processors and memory storing computer program instructions of a resource management application, the computer program instructions being executed by the processors to cause the resource management system to perform management of shared resources, including:
detecting, in response to receipt of a request to extend a current use of a shared resource, a conflict in resource data between a requested end time of the current use and a beginning time of a subsequent use of the shared resource, the requested end time being later than a scheduled beginning time for the subsequent use; and
in response to detecting the conflict, (1) receiving a permission indication with respect to the request, and (2) in response to the permission indication identifying acceptance of the request, (a) calculating a granted extension time for the current use, and (b) updating the resource data to add the granted extension time to a scheduled end time of the current use and the scheduled beginning time of the subsequent use to enable use of the shared resource without conflict.

12. The system of claim 11, wherein the shared resource is a shared meeting resource, and the resource data is meeting data.

13. The system of claim 12, wherein the shared meeting resource is a conference room.

14. The system of claim 13, wherein (1) the current use and subsequent use are respective meetings scheduled by respective meeting owners, (2) the request is received from a first client device associated with a current meeting owner for a current meeting, and (3) the permission indication is received from a second client device associated with a next meeting owner for a subsequent meeting.

15. The system of claim 11, wherein the updating of the resource data includes updating of data stored at resource client devices, the resource client devices being configured an operative to generate local notifications to respective resource users based on the updated data, the local notifications informing the resource users of an adjusted time of the current use and the adjusted beginning time of the subsequent use.

16. The system of claim 11, wherein calculating the granted extension time includes calculations based on historical resource data concerning past time extensions.

17. The system of claim 16, wherein the calculations based on historical resource data include use of a punishment factor and a reward factor, the punishment factor used to reduce the granted extension time based on past occurrences of extension requests for the shared resource, the reward factor used to offset the punishment factor and thereby increase granted extension time past on past occurrences of early completions of use of the shared resource.

18. The system of claim 17, wherein the calculations further include weighting factors representing a number of users affected by the past occurrences of extension requests and early completions of use.

19. The system of claim 16, wherein the calculations based on historical resource data are additionally based on policy data explicitly describing associated policies for granting of extensions.

20. A non-transitory computer-readable medium storing computer program instructions, the instructions being executable by a set of one or more computers to cause the computers to perform a method of managing shared resources, the method including:
detecting, in response to receipt of a request to extend a current use of a shared resource, a conflict in resource data between a requested end time of the current use and a beginning time of a subsequent use of the shared resource, the requested end time being later than a scheduled beginning time for the subsequent use; and
in response to detecting the conflict, (1) receiving a permission indication with respect to the request, and (2) in response to the permission indication identifying acceptance of the request, (a) calculating a granted extension time for the current use, and (b) updating the resource data to add the granted extension time to a scheduled end time of the current use and the scheduled beginning time of the subsequent use to enable use of the shared resource without conflict.
